(19) United States
(12) Patent Application Publication
(10) Pub. No.: US 2018/0271329 A1
(43) Pub. Date: Sep. 27, 2018

(54) Structured Shake Sleeve

(71) Applicant: Richard Charles Russett, III, Memphis, TN (US)

(72) Inventor: Richard Charles Russett, III, Memphis, TN (US)

(21) Appl. No.: 15/468,982

(22) Filed: Mar. 24, 2017

(51) Int. Cl. A47J 43/27

(52) U.S. Cl. CPC A47J 43/27

(57) ABSTRACT

This disclosure relates to a structured shake sleeve that goes around a beverage container, wherein the beverage container is used for the storing, mixing or blending of liquids for consumption, and wherein the unique design of the sleeve improves the texture and flavor of the liquid blended within beverage contained around which the sleeve is placed.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

### Field of the Invention

This disclosure relates to a structured shake sleeve for a beverage container that improves the texture and flavor of the liquid blended within the beverage container.

### Background of the Invention

Some beverage additives begin as a powder, liquid or gel and are blended with water prior to being consumed. The texture and flavor of these beverage additives detract from the drinkability and flavor of the resultant beverage. Other beverages contain impurities that impact the taste of the beverage. The present disclosure reveals a sleeve for a beverage container with a plurality of paired magnets within the sleeve for the purpose of mixing, blending, storing, or drinking a beverage, said beverage having an improved flavor as a result of the paired magnets. Several advantages result from the present disclosure including, first, when a beverage additive is mixed with water in the beverage container the resultant beverage produced is smoother and has a superior taste over the same beverage additive mixed in other containers; and second, when a beverage is stored in the container, the container causes the impurities in the container to be restricted.

### SUMMARY OF THE INVENTION

The present disclosure reveals a structured shake sleeve for a beverage container, wherein the beverage container is a protein shakers bottle, water bottle, cup, mug, glass, baby bottle, cocktail shaker, bowl, bottle, jar, can, or other type of liquid holding container, wherein the structured shake sleeve comprises a sleeve and a plurality of paired magnets contained within the sleeve. Each magnet in a pair of magnets of the plurality of paired magnets is positioned in the beverage container such that one magnet is on one side of the beverage container while its pair is located on the opposite side of the beverage container.

In determining the placement of each pair of magnets in the plurality of magnets a center-point of the beverage container is identified based on the beverage container's dimensions and from the center-point Cartesian coordinates can be extrapolated. Thus, a positive x-axis intersects one of the sides of the plurality of sides of the beverage container and a negative x-axis intersects one of the sides of the plurality of sides of the beverage container; and a positive y-axis intersects one of the sides of the plurality of sides of the beverage container and a negative y-axis intersects one of the sides of the plurality of sides of the beverage container.

In a first embodiment of the plurality of paired magnets the first set of paired magnets is positioned along the x-axis wherein the first magnet of the pair of magnets is positioned along the positive x-axis, in the side of the sleeve and the other magnet of the pair of magnets is positioned along the negative x-axis in the opposite side of the sleeve.

In a second embodiment of the plurality of paired magnets there are two sets of paired magnets wherein the first set of paired magnets is positioned along the x-axis wherein the first magnet is positioned along the positive x-axis, in the side of the sleeve and the other magnet is positioned along the negative x-axis in the opposite side of the sleeve, while the second set of paired magnets is positioned along the y-axis, having the first magnet positioned along the positive y-axis in the side of the sleeve, 90 degrees off from the first set of paired magnets and the second magnet positioned along the negative y-axis on the opposite side of the sleeve.

Additional magnet sets in the plurality of magnets are possible, wherein each magnet in the set of magnets is positioned so as to oppose its pair.

### BRIEF DESCRIPTION OF THE SEVERAL VIEWS OF THE DRAWING

FIG. 1 is a view of the structured shake sleeve positioned around a beverage contained with the

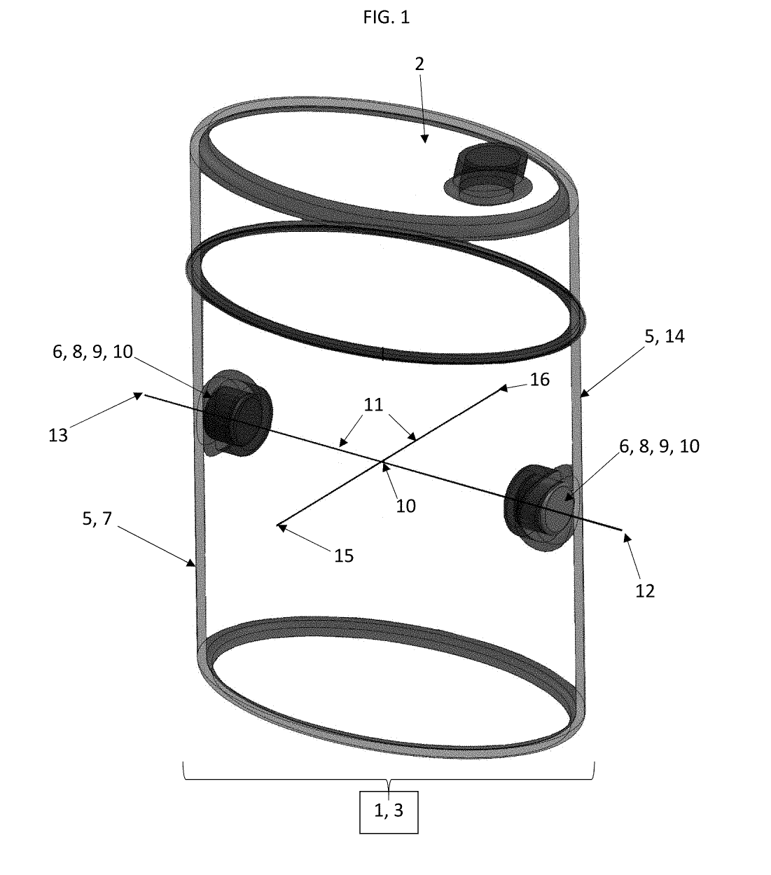

Cartesian coordinates interposed on the sleeve;

FIG. 2 is a view of the first embodiment of the structured shake sleeve including the first set of paired magnets of the plurality of paired magnets, wherein one of the magnets is positioned along the positive x-axis in the side of the sleeve and the other magnet of the pair of magnets is positioned along the negative x-axis; and

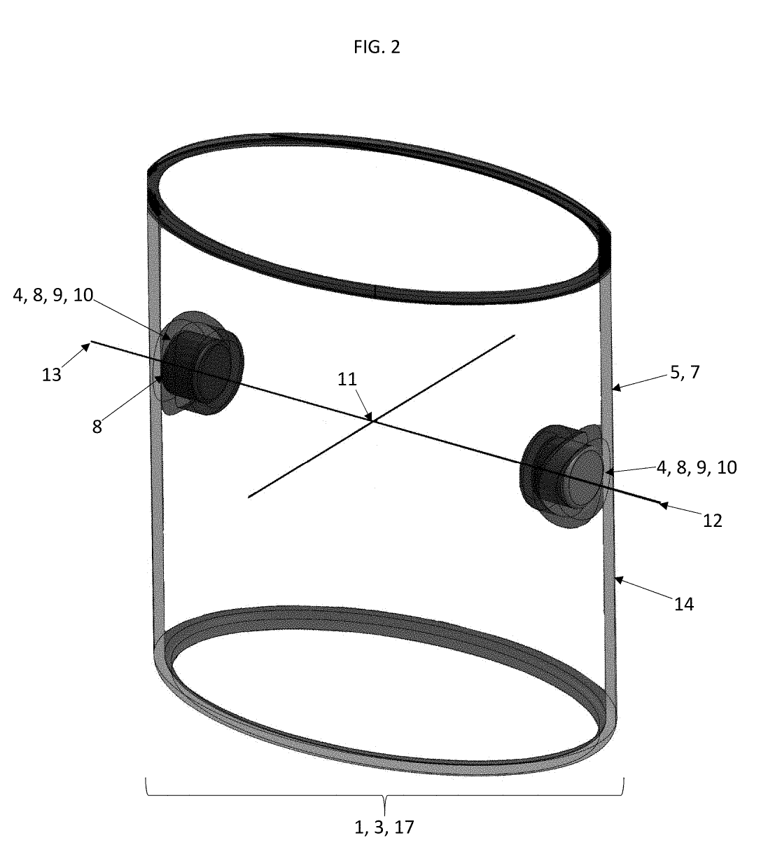

FIG. 3 is a view of the second embodiment of the structured shake sleeve including two pairs of paired magnets with the first set of paired magnets of the plurality of paired magnets, wherein one of the magnets is positioned along the positive x-axis in the side of the sleeve and the other magnet of the first pair of paired magnets is positioned along the negative x-axis in on the opposite side of the sleeve, and wherein there is the second set of paired magnets of the plurality of paired magnets, such that one of the magnets of the second set of paired magnets is positioned along the positive y-axis in the side of the sleeve 90 degrees from the first set of paired magnets and the other magnet of the second set of paired magnets is positioned along the negative y-axis in the sleeve, opposite the first magnet in the second set of paired magnets.

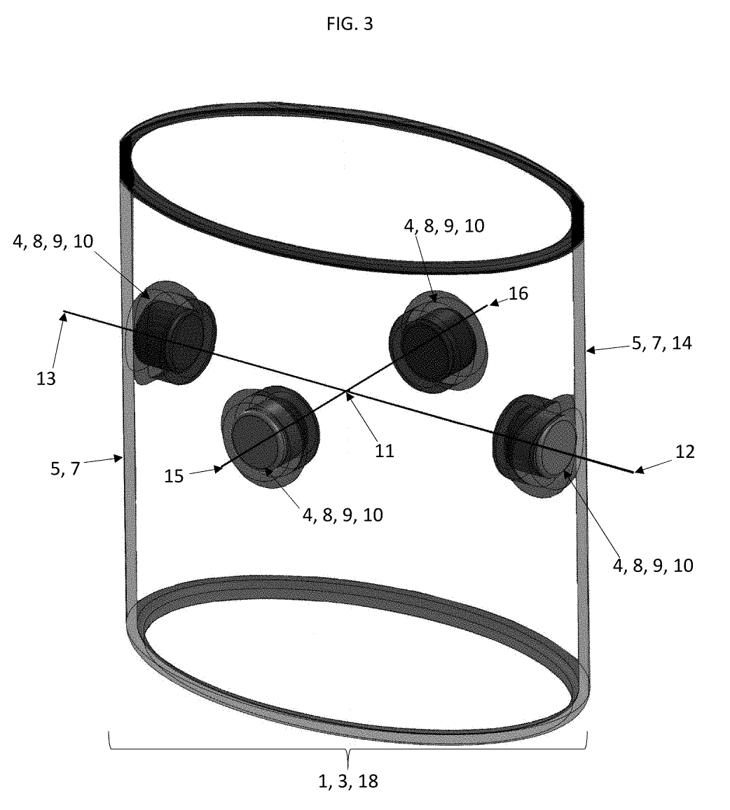

### DETAILED DESCRIPTION OF THE INVENTION

The present disclosure reveals a structured shake sleeve 1 to be placed around a beverage container 2. The beverage container 2 is a is a protein shakers bottle, water bottle, cup, mug, glass, baby bottle, cocktail shaker, bowl, bottle, jar, can, or other type of liquid holding container and comprises a plurality of sides and is capable of receiving and holding liquids, powders or gels. The structured shake sleeve 1 comprises a sleeve 3 with a plurality of sides 6 and a plurality of paired magnets 4. Each magnet 8 in a pair of magnets 9 of the plurality of paired magnets 4 is positioned in the sleeve 3 such that one magnet 8 is in one location of the sleeve 3 while another magnet 8 in the pair of magnets 9 is located on the opposite location around the sleeve 3.

In determining the placement of each pair of magnets 9 in the plurality of paired magnets 4 a center-point 10 of the sleeve 3 is identified based on the sleeve's 3 dimensions and from the center-point 10, Cartesian coordinates 11 can be extrapolated. Thus, a positive x-axis 12 intersects one of the sides 5 of the plurality of sides 6 of the sleeve 3 and a negative x-axis 13 intersects one of the sides 5 of the plurality of sides 6 of the sleeve 3; and a positive y-axis 15 intersects one of the sides 5 of the plurality of sides 6 of the sleeve 3, and is 90 degrees off from the x-axis as is established by the positive x-axis 12 and the negative x-axis 13 and a negative y-axis 16 intersects one of the sides 5 of the plurality of sides 6 of the sleeve 3.

In a first embodiment 17 of the plurality of paired magnets 4 the first set of paired magnets 9 is positioned along the x-axis wherein the first magnet 8 is positioned along the positive x-axis 12, in the side 5 of the sleeve 3 and the other magnet 8 is positioned along the negative x-axis 13 in opposite side 7 of the sleeve 3.

In a second embodiment 18 of the plurality of paired magnets 4 there are two sets of paired magnets 9 wherein the first set of paired magnets 9 is positioned along the x-axis wherein the first magnet 8 is positioned along the positive x-axis 12, in the side 5 of the sleeve 3 and the other magnet 8 is positioned along the negative x-axis 13 in the opposite side 7 of the sleeve 3, while the second set of paired magnets 9 is positioned along the y-axis, having the first magnet 8 positioned along the positive y-axis 15 in one side 14 of the plurality of sides 6 of the sleeve 3, 90 degrees off from the first set of paired magnets, and the second magnet 8 is positioned along the negative y-axis 16 in the opposite side 7 of the plurality of sides 5 of the sleeve 3.

Additional pairs of magnets 9 in the plurality of paired magnets 4 are possible, wherein each magnet 8 in the set of magnets 9 is positioned so as to oppose a magnet 8.

What is claimed:

1. A structured shake sleeve that fits around a beverage container wherein the beverage contained is used for mixing, blending, storing, or drinking of liquids and wherein the structured shake sleeve comprises:
a plurality of sides and a plurality of paired magnets;
each magnet in a pair of magnets of the plurality of paired magnets is positioned such that one magnet is located in the sleeve and the other magnet in the pair of magnets is positioned on the opposite side of the sleeve; and
wherein there is one pair of magnets such that one magnet in of the pair of magnets is positioned in one of the sides of the plurality of sides or the sleeve while the second magnet of the pair of magnets is positioned in an opposite side of the sleeve.

2. The beverage container of claim 1 wherein there is a second set of pairs of magnets of the plurality of paired magnets such that the second set of magnets has one magnet positioned in one of the sides of the plurality of sides of the sleeve, said side being 90 degrees off from the first set of pairs of magnets with the second magnet is positioned in the opposite side of the plurality of sides of the sleeve.
